(19) United States
(12) Patent Application Publication
(10) Pub. No.: US 2010/0151292 A1
(43) Pub. Date: Jun. 17, 2010

(54) APPARATUS AND METHOD OF GENERATING MECHANICAL AND ELECTRICAL ENERGY

(75) Inventors: Viktoriya FRICK, Stuttgart (DE); Rainer TAMME, Ostfildern (DE)

Correspondence Address: Muncy, Geissler, Olds & Lowe, PLLC, 4000 Legato Road, Suite 310, FAIRFAX, VA, 22033, US

(73) Assignee: DEUTSCHES ZENTRUM FUR LUFT- UND RAUMFAHRT E.V., Koln (DE)

(21) Appl. No.: 12/630,730

(22) Filed: Dec. 3, 2009

(30) Foreign Application Priority Data
Dec. 11, 2008 (DE) 10 2008 063 507.3

(51) Int. Cl. H01M 8/18

(52) U.S. Cl. 429/17; 429/20

(57) ABSTRACT

In order to provide an apparatus for generating mechanical and electrical energy from a fuel that may be operated efficiently and in a simple manner, it is proposed that the apparatus comprises:
a heat engine operated by the fuel;
a separating device, by means of which a target fraction of the fuel is separated;
a conversion device, by means of which hydrogen is generated from the target fraction; and
a fuel cell system operated by the hydrogen as a combustion gas.

The present disclosure relates to the subject matter disclosed in German patent application No. 10 2008 063 507.3 of Dec. 11, 2008, which is incorporated herein by reference in its entirety and for all purposes.

### BACKGROUND OF THE INVENTION

The present invention relates to an apparatus for generating mechanical and electrical energy from a fuel.

The invention further relates to a method of generating mechanical and electrical energy from a fuel.

Vehicles of all types that are driven by heat engines always also comprise control systems, electric motors and other consuming devices that have to be supplied with electrical energy. Both in the automotive industry and the aviation industry recent developments in particular have led to a constant increase in the electrically operated systems fitted in the vehicles, and hence to a dramatic rise in demand for electrical energy.

Traditionally vehicles are supplied with electrical energy by a generator that is operated by the heat engine, wherein the electrical energy is temporarily stored in a battery. The efficiency of this system is however limited in particular by the capacity of the battery, with the result that an adequate supply of electrical energy is ensured only during operation of the heat engine.

A more efficient method of generating electrical energy is the use of fuel cell systems. For operating fuel cell systems however a separate fuel, as a rule hydrogen, is required, which in the case of vehicle operation (or other mobile or decentralized applications) entails considerable limitations. In addition to the fuel for the heat engine, a second fuel has to be separately supplied and carried in the vehicle.

### SUMMARY OF THE INVENTION

In accordance with the present invention, an apparatus for generating mechanical and electrical energy is provided that may be operated efficiently and in a simple manner.

An apparatus in accordance with an embodiment of the present invention comprises:
a heat engine operated by the fuel;
a separating device, by means of which a target fraction of the fuel is separated;
a conversion device, by means of which hydrogen is generated from the target fraction; and
a fuel cell system operated by the hydrogen as a combustion gas.

The apparatus according to the invention makes it possible to generate mechanical (and thermal) energy by means of a heat engine and to generate electrical energy by means of a fuel cell system, wherein the apparatus may be operated by a single fuel. In this case, use is made of the possibility of generating hydrogen from one or more components of the fuel used for the heat engine by chemical conversion and using the hydrogen as a combustion gas for the fuel cell system in order to generate electrical energy.

The target fraction used to generate hydrogen is separated in advance from the fuel. The residual fraction, i.e. the portion of the fuel that is not separated for generating hydrogen, may be either supplied directly to the heat engine or initially returned to a fuel tank, for example if the heat engine is not in operation. With the apparatus according to the invention, therefore, the fuel cell system may be operated independently of the heat engine, this being a considerable advantage particularly for the supply of vehicles with electrical energy.

The heat engine in the context of the present invention preferably comprises an internal combustion engine or a gas turbine, in particular a jet engine. Internal combustion engines such as for example spark ignition engines or diesel engines are used in particular in motor vehicles, ships and propeller aircraft, while jet engines are used in jet aeroplanes. Given the use of the present invention in vehicles, the heat engine generates mechanical energy in the form of kinetic energy for driving the vehicle.

The apparatus according to the invention is however not limited to vehicles but may also be used in other fields to generate mechanical and electrical energy.

The fuel preferably comprises a mixture of aliphatic or aromatic hydrocarbons or both. These include primarily fossil fuels that are obtained by distilling mineral oil, such as for example diesel fuel, kerosene and various gasolines. However, hydrocarbon mixtures obtained from biological materials, so-called biofuels, may also be used. Generally, as a fuel in the sense of the present invention it is possible to use any hydrocarbon mixture that contains at least one component capable of generating hydrogen.

The target fraction advantageously comprises a mixture of hydrocarbons that is optimized with reference to the fuel for the generation of hydrogen by the conversion unit. Hydrogen is generated from one or more components, in particular hydrocarbon compounds, that are contained in the fuel and in the target fraction, respectively, as is described in detail further below. In the context of the present invention, by optimization of the target fraction it is therefore to be understood that the component(s) that are suitable for the generation of hydrogen are contained in a higher proportion in the target fraction than in the fuel, so that the generation of hydrogen by the conversion device may be carried out with a higher yield and/or greater efficiency. Depending on the type of fuel and the process conditions selected for hydrogen generation, these may be different components, i.e. different compositions of the optimum target fraction.

The target fraction preferably has a higher proportion of aliphatic hydrocarbons than the fuel. Aliphatic hydrocarbons, in particular paraffins and naphthenes, are particularly suitable for generating hydrogen. In comparison, aromatic hydrocarbons can generate hydrogen only very poorly and their presence under the process conditions suitable for hydrogen generation can moreover lead to the formation of carbon black. It is therefore preferred if the target fraction has as low a proportion of aromatics as possible.

It is further preferred if the target fraction has a lower proportion of sulphur-containing compounds than the fuel. The generation of hydrogen from the target fraction is effected preferably with the aid of catalysts, the activity of which is irreversibly reduced by too high a concentration of sulphur-containing compounds (so-called catalyst poisons). The functioning of the fuel cell system may also be impaired by sulphur-containing compounds. As the fuels that are used conventionally comprise a significant proportion of sulphur-containing compounds, by separating an at least partially desulphurized target fraction an enduringly effective operation of the conversion device and of the fuel cell system may be realized.

In the typical applications of the apparatus according to the invention the proportion of fuel needed to generate hydrogen and/or electrical energy is relatively low, being for example in the region of ca. 1 to 5% for the operation of aircraft. For this reason, the separation according to the invention of a target fraction for the generation of hydrogen only from a corresponding portion of the fuel is much more effective and economical than the alternative of operating the heat engine with a fuel that is optimized for hydrogen generation and/or desulphurized. The fact that the separation of the target fraction is effected inside the apparatus, i.e. for example on board a motor vehicle or an aircraft, means that only one tank for a single type of fuel and corresponding logistics have to be provided.

According to a preferred embodiment of the invention, the separating device comprises a thermal separating device. It has emerged that with the aid of a thermal separating device, i.e. by means of a separation of the target fraction based on different boiling points or melting points of the various components of the fuel, in many cases both an optimization of the target fraction for generating hydrogen and a reduction of the proportion of sulphur-containing compounds may be achieved. A thermal separation of the target fraction can moreover already be carried out with a relatively low outlay for equipment and frequently also under moderate temperature- and pressure conditions.

A preferred thermal separating device comprises a device for rectifying the fuel. For rectification the fuel is at least partially vaporized, and by means of a rectifying column or the like various components of the fuel, in particular various hydrocarbon compounds, are then separated on the basis of their different boiling points. The rectification may be carried out in one or more stages, and individual components or groups of a plurality of components may be separated. The thermal energy needed for rectification may in this case be supplied advantageously by the waste heat of the heat engine, with the result that the efficiency of the apparatus according to the invention is not or is hardly reduced by operation of the separating device.

The target fraction separated by the separating device by means of rectification preferably comprises one or more lower-boiling fractions of the fuel. This so-called top fraction in many cases contains a higher proportion of components that are suitable for generating hydrogen as well as a lower proportion of sulphur than the higher-boiling bottom fraction. The one or more lower-boiling fractions may be condensed in the course of rectification, or they are supplied to the conversion device directly in a gaseous state, this enabling particularly easy process management.

According to a further advantageous embodiment of the apparatus according to the invention the thermal separating device comprises a device for fractional crystallization of the fuel. Various types of fractional crystallization are known, of which cooling crystallization is particularly preferred. In this method of thermal separation the fuel is cooled until a fraction of the components contained therein, in particular a fraction of the hydrocarbons, precipitate and/or crystallize out from the liquid fuel. In order that the cooling of the fuel required for this purpose may be realized with as low an expenditure of energy as possible, a low ambient temperature may advantageously be utilized, especially if the apparatus according to the invention is used in aircraft, where, at a typical cruising height of ca. 10 to 12 km, outside temperatures of up to −50° C. prevail. Utilization of the outside temperature may be effected easily, for example by means of heat exchangers.

The target fraction in the case of fractional crystallization preferably comprises one or more fractions of the fuel that crystallize out, i.e. one or more components of the fuel that have a higher melting point than the remaining components. Here, it has emerged that in particular the proportion of sulphur-containing compounds in the fraction of the fuel that crystallizes out is reduced, in some cases markedly, compared to the residual fraction. At the same time the fraction that crystallizes out is typically optimized for the generation of hydrogen compared to the fuel.

Depending on the type of fuel and/or the conditions selected for the generation of hydrogen, thermal separation of the target fraction by means of rectification or by means of fractional crystallization may be more advantageous and/or yield better results. Both methods may be carried out in each case in one or more stages in order as far as possible to increase the efficiency of the hydrogen generation and hence of the apparatus according to the invention as a whole. In particular, rectification may also be combined with fractional crystallization for separating the target fraction.

As already mentioned above, the conversion device advantageously comprises a catalyst for the catalytic dehydrogenation of aliphatic and/or aromatic hydrocarbons in the target fraction. By virtue of the fact that the target fraction is preferably optimized for the generation of hydrogen, such a dehydrogenation of the hydrocarbon compounds contained in the target fraction may, given selection of a suitable catalyst, be carried out very efficiently and with a high yield of hydrogen. With regard to the reaction processes that occur in this case, a term that is occasionally also used is reforming of the hydrocarbons.

As starting materials for the catalytic dehydrogenation preferably aliphatic hydrocarbons having four to twelve carbon atoms are used, of which there is advantageously a higher proportion contained in the target fraction than in the fuel. Typical dehydrogenation and/or reforming reactions comprise in particular the conversion of alkanes (paraffins) into alkenes (olefins), cycloalkanes (naphthenes) or aromatic compounds, the conversion of cycloalkanes into aromatic compounds, and the conversion of monounsaturated alkenes into polyunsaturated alkenes. The products formed during these conversion reactions (in addition to the hydrogen) may be supplied to the heat engine or returned to the fuel tank.

The catalyst for the dehydrogenation reaction preferably comprises a platinum-, chromium-, nickel-, palladium- or iron catalyst. Through the use of platinum on an aluminium oxide support it is possible to catalyse for example the dehydrogenation of cyclohexane to benzene, of decalin to naphthalene and of heptane to toluene, as well as the dehydrogenation of undecane, which may lead to various products such as 1-undecene, 1-methyldecalin, pentyl benzene or 1-methyl tetralin. Chromium(III) oxide on aluminium oxide catalyses i.a. the dehydrogenation of butane to butene as well as of isobutane to isobutylene. These and further catalysts for the dehydrogenation and/or reforming of hydrocarbons are prior art and may be selected in dependence upon the composition of the target fraction, which in turn is dependent upon the fuel and the separating method that are used.

The dehydrogenation reaction is effected advantageously under relatively mild pressure- and temperature conditions. In many cases the reaction may be carried out under normal pressure and at temperatures in the region of 100 to 1500° C., often also at temperatures below 300° C. The thermal energy needed to carry out the reaction may be supplied in this case by the heat engine.

According to a preferred embodiment of the invention the apparatus further comprises a purification device for purifying the hydrogen. By means of an additional purification of the hydrogen generated by the conversion device a possible impairment of the fuel cell system as a result of impurities may be prevented. In the course of purification of the hydrogen highly volatile products arising in the course of the dehydrogenation reaction may in particular be separated by means of a cold trap or the like.

The hydrogen generated by means of the conversion device and optionally purified is preferably supplied directly to the fuel cell system as a combustion gas. Alternatively or additionally it may be provided that the hydrogen is temporarily stored.

The fuel cell system of the apparatus according to the invention may comprise in particular an alkaline fuel cell (AFC), a membrane fuel cell (PEFC), a phosphoric acid fuel cell (PAFC), a molten carbonate fuel cell (MCFC) or an oxide ceramic fuel cell (SOFC). All of these types of fuel cell are operated preferably with atmospheric oxygen from the environment as an oxidizer gas, with the result that no storage of the oxidizer gas is required. The fuel cell system may comprise one or more fuel cell units.

The apparatus according to the invention may be used particularly advantageously to operate a land-vehicle, water-craft or aircraft. By virtue of the invention it is possible in an efficient manner to generate from a single fuel the mechanical (kinetic) energy needed to drive the vehicle as well as sufficient electrical energy to be able also to supply extensive electrical systems of the vehicle. Particularly in the case of aircraft, the apparatus according to the invention enables an aircraft architecture described as a “more electric aircraft”, in which hydraulic control systems are entirely or predominantly replaced by electrical systems, and in which as a result there is a markedly increased demand for electrical energy.

The present invention is however not limited to use in vehicles but may be used for example also in the context of decentralized combined heat and power generating systems.

In accordance with the present invention, a method of generating mechanical and electrical energy is further provided that may be carried out efficiently and in a simple manner.

A method in accordance with an embodiment of the invention comprises:
providing a fuel for operating a heat engine;
separating a target fraction of the fuel;
generating hydrogen from the target fraction; and
using the hydrogen as a combustion gas for a fuel cell system.

Special advantages of the method according to the invention have already been explained in connection with the apparatus according to the invention.

Separation of the target fraction in the method according to the invention is effected preferably by means of a thermal separation method. The thermal separation method may comprise in particular a rectification and/or a fractional crystallization of the fuel, as has already been explained in detail above.

It is particularly advantageous if heat generated by the heat engine is used to carry out the thermal separation method. This concerns in particular an at least partial vaporization of the fuel in the case of rectification in order to separate preferably one or more lower-boiling fractions of the fuel as a target fraction. Separation of the target fraction may therefore be carried out without substantially impairing the overall efficiency of the method.

The method according to the invention may be used particularly advantageously to operate a land-vehicle, water-craft or aircraft, as has likewise already been described in connection with the apparatus according to the invention. It is particularly advantageous if the ambient temperature of the craft is used to carry out the thermal separation method. This applies in particular to very low outside temperatures during operation of an aircraft, which may be used both for cooling the fuel in the case of fractional crystallization and for the condensation of one or more higher-boiling fractions in the case of rectification.

Further preferred embodiments of the method according to the invention have likewise already been described in connection with the apparatus according to the invention.

These and further advantages of the present invention are described in detail below by way of embodiments with reference to the figures of the drawings.

### BRIEF DESCRIPTION OF THE DRAWINGS

FIG. 1: a diagrammatic representation of an embodiment of the apparatus according to the invention;

FIG. 2: a graph relating to the temperature characteristic during the fractional crystallization of kerosene;

FIG. 3: a graph relating to the pressure- and temperature characteristic during the rectification of kerosene;

FIG. 4: a graph relating to the sulphur content in various fractions of kerosene during the rectification.

### DETAILED DESCRIPTION OF THE INVENTION

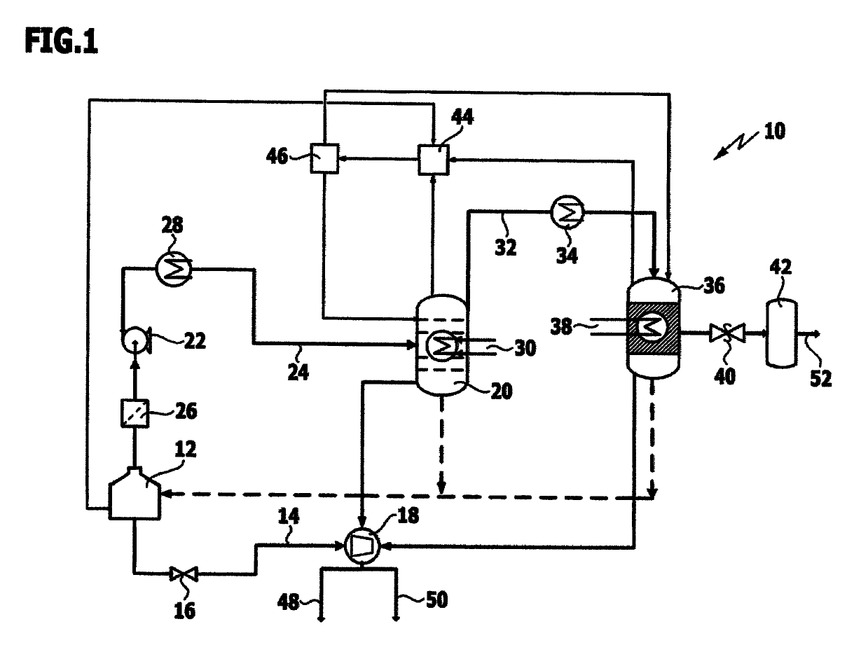

FIG. 1 shows a diagrammatic and simplified representation of an embodiment of an apparatus according to the invention, which is denoted as a whole by 10.

The apparatus 10 comprises a fuel tank 12, in which a fuel, for example kerosene, gasoline or diesel fuel, is stored. The fuel tank 12 is connected by a fuel line 14 with an adjustable valve 16 to a heat engine 18. The heat engine 18 may be in particular a jet engine or an internal combustion engine.

The apparatus 10 further comprises a thermal separating device 20, to which the fuel may be supplied from the fuel tank 12 by means of a pump 22. A filter 26 and a heat exchanger 28 are further connected in the supply line 24 between the fuel tank 12 and the thermal separating device 20.

According to a variant of the apparatus 10 the thermal separating device 20 comprises a device for rectifying the fuel, i.e. in particular a rectifying column, by means of which a mixture of aliphatic and/or aromatic hydrocarbons may be separated into one or more lower-boiling fractions (top fraction) and one or more higher-boiling fractions (bottom fraction).

According to a further variant of the apparatus 10 the thermal separating device 20 comprises a device for crystallizing the fuel. By cooling a hydrocarbon mixture, one or more fractions that crystallize out may be separated as a solid from the liquid residual fraction of the mixture by means of such a device. A device for fractional crystallization of the fuel advantageously comprises a precooler and a main cooler.

The thermal separating device 20 comprises one or more heating and/or cooling elements 30, by means of which for carrying out the thermal separating method heat may be supplied to or removed from the fuel, depending on whether rectification or fractional crystallization is carried out.

The thermal separating device 20 is connected to a conversion device 36 by a further supply line 32 and a heat exchanger 34 inserted therebetween. According to the present embodiment of the apparatus 10 according to the invention the conversion device 36 comprises a reactor for the catalytic dehydrogenation of one or more hydrocarbons in the target fraction separated from the fuel. In this case, by means of a heating element 38 an optimum reaction temperature for the dehydrogenation reaction may be adjusted.

The conversion device 36 is connected by a pressure regulating valve 40 to a fuel cell system 42. The fuel cell system 42 comprises one or more fuel cell units, to which the hydrogen generated in the conversion device 36 may be supplied as a combustion gas.

The apparatus 10 further comprises a measuring- and control system for carrying out the method according to the invention, which system is illustrated in FIG. 1 in the form of a measuring device 44 and a control device 46. By means of the measuring device 44 various process parameters in the separating device 20 and the conversion device 36 may be detected, such as for example the temperature and pressure of the fuel and of the various fractions, the reaction temperature during catalytic dehydrogenation, the hydrogen partial pressure, as well as the time rates of change of these parameters. Furthermore, the fill level in the fuel tank 12 and optionally the composition of the fuel may be detected. In dependence upon the data determined by the measuring device 44 the process management may be controlled by means of the control device 46.

The method according to the invention works as follows: the fuel provided in the fuel tank 12 is supplied through the fuel line 14 and the valve 16 to the heat engine 18. During operation of the heat engine 18 both mechanical and thermal energy are generated (indicated by the arrows 48 and 50). Whereas the mechanical energy is used, depending on the application of the apparatus 10, for example to drive a motor vehicle or an aircraft, some of the thermal energy generated by the heat engine 18 may be used in an efficient manner in the method according to the invention, in particular to supply the necessary thermal energy to the thermal separating device 20 by means of the heating element 30 and to the conversion device 36 by means of the heating element 38.

In the method according to the invention a low proportion of the fuel, typically around 1 to 5% of the fuel quantity needed to operate the heat engine, is used for the generation of electrical energy by the fuel cell system 42. For this purpose, a corresponding amount of the fuel is supplied from the fuel tank 12 through the supply line 24 to the thermal separating device 20. By means of the filter 26 solid impurities in the fuel may previously be removed. The heat exchanger 28 is used to bring the fuel to a preset temperature before it is supplied to the thermal separating device 20, so as to allow the thermal separating method to be carried out in as reproducible a manner as possible. Depending on the type of separating method used, the fuel is accordingly preheated or precooled by means of the heat exchanger 28.

If rectification is carried out as a thermal separating method in the method according to the invention, the fuel supplied to the thermal separating device 20 is heated with the aid of the heating element 30 and at least partially vaporized. Various fractions of the fuel (i.e. in particular various hydrocarbons) are separated with the aid of a rectifying column on the basis of their different boiling points. One or more lower-boiling fractions, which compared to the fuel are optimized for the generation of hydrogen, are separated as a target fraction.

The rectification of the fuel by the thermal separating device 20 may be carried out either under normal pressure or under reduced pressure.

According to a further variant of the apparatus 10 the thermal separating method comprises fractional crystallization of the fuel. In this case, the fuel is cooled by one or more cooling elements 30 until one or more components (i.e. in particular hydrocarbons) crystallize out because they have a higher melting point than the remaining components. According to a preferred process management the fuel is initially cooled (for example down to −40° C. in the case of kerosene) in a precooling unit, and the precooled fuel is then further cooled (for example down to −90° C. in the case of kerosene) to the point of crystallization in a main cooling unit. The solid that crystallizes out may easily be separated as a target fraction from the liquid residual fraction.

When carrying out fractional crystallization, it is possible, particularly given use of the apparatus 10 in an aircraft, to utilize the lower outside temperature for cooling the fuel by means of the cooling element or cooling elements 30.

The target fraction resulting from the thermal separating method is supplied through the supply line 32 to the conversion device 36. Since the target fraction may arise initially in a solid, liquid or gaseous form, depending on the type of thermal separating method, it is previously brought to a preset temperature by means of the heat exchanger 34 in order to promote efficient and reproducible operation of the conversion device 36.

The target fraction supplied to the conversion device 36 is dehydrogenated and/or reformed while simultaneously generating hydrogen by the action of a suitable catalyst, in particular a platinum-, chromium-, nickel-, palladium- or iron catalyst. The target fraction contains one or more components that may be dehydrogenated, in particular aliphatic hydrocarbons. Depending on the composition of the target fraction and the type of catalyst used, the dehydrogenation reaction may be carried out at temperatures in the region of ca. 100 to 1500° C., wherein the required thermal energy is supplied by the heating element 38.

The hydrogen generated by the conversion device 36 is separated from the remaining products of the dehydrogenation reaction and is optionally subjected to further purification by means of a purification device (not shown in FIG. 1). It is supplied through the pressure regulating valve 40 to the fuel cell system 42 for the generation of electrical energy (indicated by the arrow 52). As an oxidizer gas for the fuel cell system 42, atmospheric oxygen from the environment is used.

Both the residual fraction of the fuel arising from the thermal separating method and the products formed during catalytic dehydrogenation may be supplied from the thermal separating device 20 and the conversion device 36 directly to the heat engine 18. Alternatively, however, a return to the fuel tank 12 is also possible (shown by dashed arrows). In both cases these components, despite being of an altered composition compared to the fuel, have no substantial influence on the operation of the heat engine 18 because they make up only a very low proportion of the fuel quantity that is supplied as a whole to the heat engine.

### Examples

From the experiments described below it was possible to demonstrate that by means of the separating methods used in the context of the present invention, in particular by means of the thermal separating methods of fractional crystallization and rectification described above, the proportion of sulphur-containing compounds in the target fraction may be markedly reduced compared to the fuel. What is more, by means of these methods the composition of the target fraction may be optimized for the generation of hydrogen compared to the fuel.

The experiments were conducted with kerosene (type Jet A-1), which is used as a fuel for jet engines of aircraft. Kerosene comprises a complex mixture of a large number of aliphatic and aromatic hydrocarbons. It also contains various sulphur-containing compounds, namely typically 0.3 wt. % sulphides and 0.003 wt. % mercaptans, wherein the various sulphur compounds have boiling points in the region of ca. 35 to 240° C. Besides these, lower quantities of disulphides and free sulphur are also contained. In this amount, sulphur compounds act as a catalyst poison upon the metal catalysts used for catalytic dehydrogenation, with the result that kerosene as such may not be used to generate hydrogen.

In the experiments relating to rectification, diesel fuel was also additionally tested.

### Fractional Crystallization

Kerosene (Jet A-1) was subjected to fractional crystallization, wherein the kerosene was cooled in each case for a period of 5 hours initially in a precooler to ca. −30° C. and then in a main cooler to ca. −75° C.

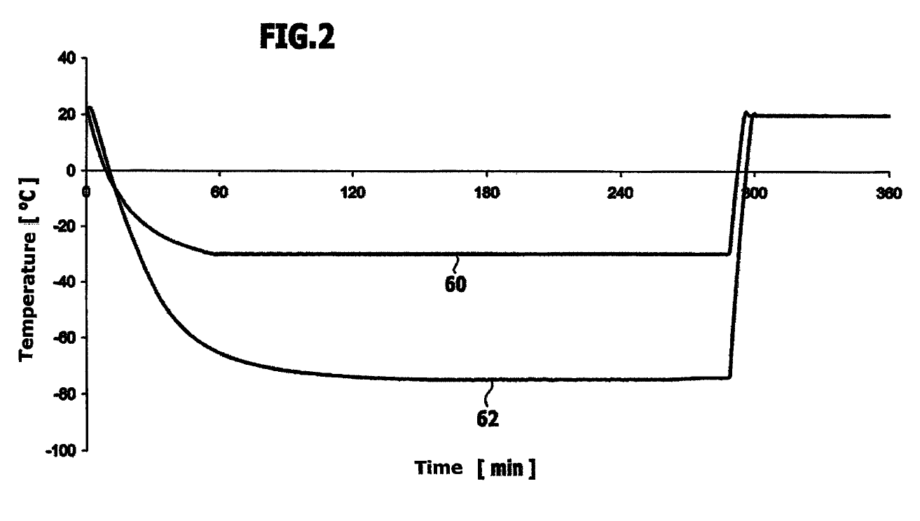

The exact temperature characteristic during fractional crystallization is shown in the graph of FIG. 2. The curve 60 indicates the temperature characteristic in the precooler and the curve 62 the temperature characteristic in the main cooler.

The kerosene fraction (target fraction) that crystallized out during the main cooling period was separated from the still liquid fraction (residual fraction) and the proportion of sulphur-containing compounds in both fractions was determined by means of gas chromatography. The result of a plurality of experiments was that 97-99% of the sulphur content of the kerosene was found in the residual fraction, while the target fraction contained only 1-3% of the sulphur-containing compounds.

The target fraction of the kerosene thus obtained by fractional crystallization can be used, because of the markedly reduced sulphur content, without any problem for the catalytic dehydrogenation in the method according to the invention.

The composition of the target fraction and of the residual fraction of the kerosene after fractional crystallization with regard to various types of hydrocarbon was likewise analyzed by means of gas chromatography.

The result is shown in the following Table 1. This indicates in each case what proportion of the various types of hydrocarbon, relative to their total proportion in the kerosene, was found in the target fraction and in the residual fraction (owing to measuring inaccuracies the totals differ slightly from 100%).

TABLE 1

| Hydrocarbons | Target fraction [%] | Residual fraction [%] |
|---|---|---|
| cycloalkanes (naphthenes) | 37.25 | 62.89 |
| n-alkanes (paraffins) | 41.44 | 58.32 |
| isoalkanes (isoparaffins) | 9.75 | 90.10 |
| alkenes (olefins) | 0.00 | 101.73 |
| aromatic compounds | 5.25 | 94.82 |
| Other | 8.69 | 91.12 |

A considerable proportion of the cycloalkanes and the n-alkanes (ca. 37% and ca. 41% respectively) is located after fractional crystallization in the target fraction, while over 90% of all the other types of hydrocarbon (isoalkanes, alkenes, aromatic compounds and other hydrocarbons) remain in the residual fraction.

Cycloalkanes (naphthenes) and n-alkanes (paraffins) are preferred starting materials for the generation of hydrogen by catalytic dehydrogenation, wherein cycloalkanes are typically dehydrogenated to form aromatics and n-alkanes are typically dehydrogenated to form alkenes. For this purpose, platinum- and/or chromium catalysts in particular may be used.

Only ca. 5% of the content of aromatic hydrocarbons, which are hardly suitable for dehydrogenation and may lead to the formation of carbon black, were located in the target fraction.

In addition to reducing the sulphur content, fractional crystallization may therefore achieve a marked optimization of the composition of the hydrocarbon mixture with regard to the generation of hydrogen.

### Rectification

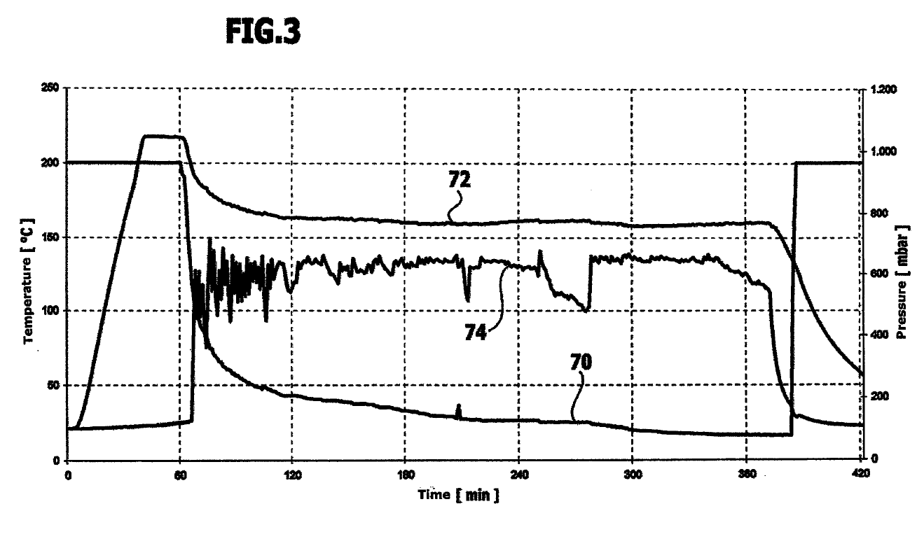

A rectification of kerosene (Jet A-1) was carried out, wherein the hydrocarbon mixture contained therein was separated into 40 different fractions. The rectification was effected under reduced pressure, wherein the exact characteristics of the pressure (curve 70) as well as of the bottom temperature (curve 72) and the top temperature (curve 74) of the rectifying column are represented in the graph of FIG. 3.

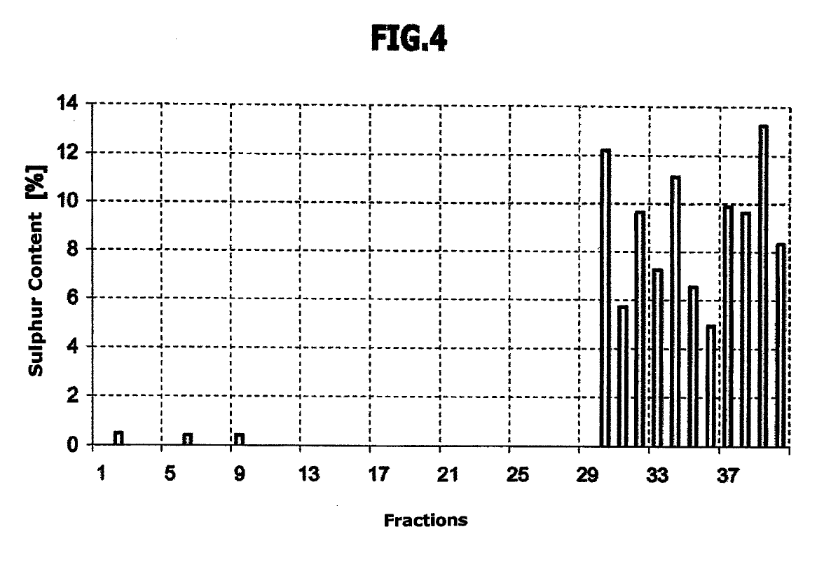

The graph of FIG. 4 shows the proportion—determined by means of gas chromatography—of sulphur-containing compounds in the individual fractions, in each case relative to the total sulphur content of the kerosene. Almost the entire sulphur content was found after rectification in the higher-boiling fractions 30 to 40, while the lower-boiling fractions 1 to 29 contained only ca. 0.5% of the sulphur-containing compound of the kerosene.

This clear result demonstrates that rectification may also be used to separate a target fraction with a considerably reduced sulphur content from a fuel. The clear distribution of the sulphur-containing compounds among the various fractions according to FIG. 4 also makes it plain that even with a much lower number of fractions than in the experiment described here, i.e. even with relatively simple process management and a low outlay for equipment, an optimized target fraction may be separated using the method according to the invention.

As a further example, a rectification of diesel fuel was also carried out. In this case, the main content of sulphur-containing compounds was separated with the lower-boiling fractions 1 to 17, while the higher-boiling fractions 18 to 35 contained only ca. 1.5% of the sulphur content. The reversal of the distribution of the sulphur content compared to kerosene is explained by the fact that the components of the diesel fuel have on average higher boiling points than those of the kerosene. Nevertheless, here too, a very clear separation was achieved.

Through the use of the higher-boiling fractions 18 to 35 as a target fraction it is therefore possible, also in the case of diesel fuel, to achieve an effective desulphurization of the hydrocarbons used for hydrogen generation.

1. An apparatus for generating mechanical and electrical energy from a fuel, comprising
a heat engine operated by the fuel;
a separating device, by means of which a target fraction of the fuel is separated;
a conversion device, by means of which hydrogen is generated from the target fraction; and
a fuel cell system operated by the hydrogen as a combustion gas.

2. The apparatus according to claim 1, wherein the heat engine comprises an internal combustion engine or a gas turbine.

3. The apparatus according to claim 1, wherein the fuel comprises a mixture of aliphatic or aromatic hydrocarbons or both.

4. The apparatus according to claim 3, wherein the target fraction comprises a mixture of hydrocarbons that is optimized with reference to the fuel for the generation of hydrogen by the conversion device.

5. The apparatus according to claim 4, wherein the target fraction has a higher proportion of aliphatic hydrocarbons than the fuel.

6. The apparatus according to claim 1, wherein the target fraction has a lower proportion of sulphur-containing compounds than the fuel.

7. The apparatus according to claim 1, wherein the separating device comprises a thermal separating device.

8. The apparatus according to claim 7, wherein the thermal separating device comprises a device for rectifying the fuel.

9. The apparatus according to claim 8, wherein the target fraction comprises one or more lower-boiling fractions of the fuel.

10. The apparatus according to claim 7, wherein the thermal separating device comprises a device for fractional crystallization of the fuel.

11. The apparatus according to claim 10, wherein the target fraction comprises one or more fractions of the fuel that crystallize out.

12. The apparatus according to claim 1, wherein the conversion device comprises a catalyst for the catalytic dehydrogenation of aliphatic or aromatic hydrocarbons or both in the target fraction.

13. The apparatus according to claim 12, wherein the catalyst comprises a platinum-, chromium-, nickel-, palladium- or iron catalyst.

14. The apparatus according to claim 1, further comprising a purification device for purifying the hydrogen.

15. The apparatus according to claim 1, wherein the fuel cell system comprises an alkaline fuel cell (AFC), a membrane fuel cell (PEFC), a phosphoric acid fuel cell (PAFC), a molten carbonate fuel cell (MCFC) or an oxide ceramic fuel cell (SOFC).

16. A land-vehicle, water-craft or aircraft, comprising the apparatus according to claim 1.

17. A method of generating mechanical and electrical energy from a fuel, comprising:
providing a fuel for operating a heat engine;
separating a target fraction of the fuel;
generating hydrogen from the target fraction; and
using the hydrogen as a combustion gas for a fuel cell system.

18. The method according to claim 17, wherein the heat engine comprises an internal combustion engine or a gas turbine.

19. The method according to claim 17, wherein the fuel comprises a mixture of aliphatic or aromatic hydrocarbons or both.

20. The method according to claim 19, wherein the target fraction comprises a mixture of hydrocarbons that is optimized with reference to the fuel for the generation of hydrogen.

21. The method according to claim 20, wherein the target fraction has a higher proportion of aliphatic hydrocarbons than the fuel.

22. The method according to claim 17, wherein the target fraction has a lower proportion of sulphur-containing compounds than the fuel.

23. The method according to claim 17, wherein separation of the target fraction is effected by means of a thermal separating method.

24. The method according to claim 23, wherein the thermal separating method comprises rectification of the fuel.

25. The method according to claim 24, wherein the target fraction comprises one or more lower-boiling fractions of the fuel.

26. The method according to claim 23, wherein the thermal separating method comprises fractional crystallization of the fuel.

27. The method according to claim 26, wherein the target fraction comprises one or more fractions of the fuel that crystallize out.

28. The method according to claim 23, wherein heat generated by the heat engine is used to carry out the thermal separating method.

29. The method according to claim 17, wherein the generation of hydrogen comprises a catalytic dehydrogenation of aliphatic and/or aromatic hydrocarbons in the target fraction.

30. The method according to claim 29, wherein the catalytic dehydrogenation is effected with the aid of a platinum-, chromium-, nickel-, palladium- or iron catalyst.

31. The method according to claim 17, further comprising a purification of the generated hydrogen.

32. The method according to claim 17 for operating a land-vehicle, water-craft or aircraft.

33. The method according to claim 32, wherein the ambient temperature of the vehicle or craft is utilized for carrying out the thermal separating method.
